(19) United States
(12) Patent Application Publication
(10) Pub. No.: US 2020/0191276 A1
(43) Pub. Date: Jun. 18, 2020

(54) DEVICE WITH TWO STRUCTURAL COMPONENTS AND GAS TURBINE ENGINE

(71) Applicant: Rolls-Royce Deutschland Ltd & Co KG, Blankenfelde-Mahlow (DE)

(72) Inventor: Sebastian KOPP, Berlin (DE)

(21) Appl. No.: 16/713,683

(22) Filed: Dec. 13, 2019

(30) Foreign Application Priority Data
Dec. 14, 2018 (DE) 10 2018 132 316.6

(51) Int. Cl. F16J 15/34

(52) U.S. Cl. CPC F16J 15/3492; F16J 15/164; F16J 15/344

(57) ABSTRACT

A device has two components with at least one of the components being rotatable relative to the other component. The components each have oil-conducting regions. The components are operatively connected to one another via an overlap region to transfer oil. The overlap region is delimited by a sealing unit which has at least one slide ring seal. The slide ring seal includes at least one recess which is operatively connected to the oil-conducting regions and which is formed to run in the direction of a sealing side, averted from said oil-conducting regions, of the slide ring seal. Via the sealing side, the slide ring seal bears sealingly against at least one of the components. An end, which faces toward the sealing side, of the recess is spaced apart from the sealing side in an axial direction of the slide ring seal.

This application claims priority to German Patent Application DE102018132316.6 filed Dec. 14, 2018, the entirety of which is incorporated by reference herein.

The present disclosure relates to a device having two components, wherein at least one of the components is designed to be rotatable relative to the other component, and the components each have oil-conducting regions. The present disclosure also relates to a gas turbine engine for an aircraft.

EP 0 185 134 A1 has disclosed a wear indicator for a slide ring seal. The wear indicator outputs a control signal after a predefined thickness of a wearing layer of a static slide ring included in the slide ring seal has worn away. Here, the wear indicator has two electrodes which are arranged so as to be angularly offset with respect to one another with the same radial spacing and which are composed of graphite. The electrodes are each inserted in an insulated manner into axially parallel blind bores which proceed from the rear side of the slide ring, and said electrodes are connected to an evaluation circuit which responds to changes in resistance. When a wearing layer thickness has worn away, the electrodes come into contact with the sliding surface of the rotating counterpart ring and apply a graphite trace to the latter. The graphite trace connects the two electrodes in electrically conductive fashion even in the case of a non-conductive counterpart ring. If the slide ring is produced from conductive material, an electrode can be omitted. Then, the evaluation circuit is connected to the remaining electrode and to the slide ring.

The wear indicator is disadvantageously characterized by high outlay in terms of apparatus.

It is sought to provide a device and a gas turbine engine in the case of which a degree of wear of a slide ring seal can be determined with low outlay in terms of apparatus.

Said object is achieved by means of a device and by means of a gas turbine engine having the features of patent claims 1 and 11 respectively.

According to a first aspect, a device having two components is provided. At least one of the components is designed to be rotatable relative to the other component. The components furthermore each have oil-conducting regions. For the purposes of transferring oil, the oil-conducting regions are operatively connected via an overlap region between the components. The overlap region is delimited between the components by means of a sealing unit which has at least one slide ring seal.

The slide ring seal is designed with at least one recess which is operatively connected to the oil-conducting regions. Additionally, the recess is formed so as to run in the direction of a sealing side, averted from the oil-conducting regions, of the slide ring seal. By means of the sealing side, the slide ring seal bears sealingly against at least one of the components. An end, which faces toward the sealing side, of the recess is spaced apart from the sealing side in an axial direction of the slide ring seal.

The present disclosure relates to devices having two components, wherein one of the components may be designed to be rotatable and the other component may be designed in each case to be rotationally fixed to a housing. The present disclosure furthermore also relates to devices whose components are both designed to be rotatable, and between which a rotational speed difference may exist.

During the operation of the device, it is specifically possible for a rotational speed difference to prevail between the sealing surface and the component against which the sealing surface of the slide ring seal bears. This rotational speed difference gives rise, in the region of the sealing surface, to wear owing to abrasive material removal from the slide ring seal. The abrasive material removal gives rise to increasing wear of the slide ring seal or of a piston ring. Here, the wear is dependent on operating conditions, such as rotational speeds, pressure differences acting on the slide ring seal, contamination and the like, but also on installation conditions, for example a surface quality, an offset between the components, an oblique position and the like. These influential factors make a reliable prediction of the wear of a slide ring seal, and thus also of the service life of a slide ring seal, more difficult.

By means of the device according to the present disclosure, premature wear of a slide ring seal can be detected reliably and at an early point in time. Here, the detection is possible already before a point in time before an unacceptable or complete loss of the sealing performance of the slide ring seal occurs.

By means of the device according to the present disclosure, wear of a slide ring seal can be performed by means of an artificially generated leakage, on the basis of which excessive or premature wear of the slide ring seal can be detected. On the basis of this information, it is possible for an exchange of a slide ring seal to be planned in good time, whereby a failure of a machine equipped with the device, such as a gear box or a gas turbine engine having a gear box of said type, can be avoided in a straightforward manner.

For this purpose, the slide ring seal preferably has, proceeding from the oil-conducting regions, which commonly also constitute the high-pressure side of the slide ring seal, at least one bore and/or one groove which are/is formed into the slide ring seal in the direction of the pressure gradient prevailing at the slide ring seal. Here, the recess however does not extend over the entire axial width of the slide ring seal.

The axial depth of the recess is in this case configured in a manner dependent on the expected wear of the slide ring seal. With such a design, it is now possible for excessive leakage from the high-pressure side in the direction of the low-pressure side of the slide ring seal to be prevented over a predefined service life of the slide ring seal.

According to a further aspect of the present disclosure, the recess opens out in the region of the sealing side when a defined degree of wear of the slide ring seal is reached in the region of the sealing side. Then, an oil volume flow can be conducted through the recess from the oil-conducting regions in the direction of the sealing side. The oil volume flow conducted through the recess gives rise, in the region of the oil-conducting regions, to a pressure drop which is available as an indicator of a defined degree of wear being reached in the region of the slide ring seal.

If the oil volume flow that can be conducted through the recess is greater than or equal to a predefined leakage oil volume flow, then it is possible to easily determine when the defined degree of wear has been reached in the region of the slide ring seal. Here, the pressure drop can be determined by measurement with little outlay for example by means of a pressure sensor arranged in the region of the oil-conducting regions of the components.

According to a further aspect, the predefined leakage oil volume flow is smaller than a degree of leakage proceeding from which an oil volume flow conducted from the component into the rotatable component is smaller than a threshold value. In this way, it is in turn ensured that a component that is to be supplied with oil via the oil-conducting regions of the components is charged with an oil volume flow which is sufficient to maintain the functioning of the component. Such an oil volume flow may for example be provided for the cooling and/or lubrication of the component. It is additionally also possible for the oil volume flow that is fed to the component to constitute a pressure signal, in a manner dependent on which the component is to be actuated to the desired degree.

In a structurally simple embodiment of the device according to the present disclosure that can be produced with little outlay, the recess is designed as a blind bore running in an axial direction in the slide ring seal.

As an alternative or in addition to this, it is also possible for the recess to be formed of an axial groove which is arranged in an outer side of the slide ring seal.

According to a further aspect, the preferably axial spacing between the end of the recess and the sealing side is configured to have a defined extent. Here, the spacing is such that an expected degree of operational wear of the slide ring seal in the region of the sealing surface over a defined operating duration, which corresponds to a defined abrasive removal of material, is smaller than the wall thickness, corresponding to the spacing, of the slide ring seal between the sealing surface and the end of the recess.

It is thus in turn ensured with little outlay that a period of time between two maintenance operations during which the slide ring seal is exchanged is shorter than the time period within which, in the region of the slide ring seal, a degree of wear that impairs the sealing performance of the slide ring seal occurs in the region of the slide ring seal.

The rotatable component may radially surround the other component, and the slide ring seal may be arranged in a radial groove of the other component.

It is possible here for the slide ring seal to bear sealingly with its radial outer side against an inner side of the rotating component and to bear sealingly with the axial sealing side against a wall of the radial groove. Then, the wear detection in the region of the slide ring seal can be performed in a straightforward manner by means of the device according to the present disclosure.

In the case of a device which is easy to produce and which can be operated with little outlay, the recess is connected, in the region of a sealing side situated opposite the sealing side, to the oil-conducting regions.

The slide ring seal can be designed with small dimensions, and a load limit of the slide ring seal is impaired only to a small extent, if the slide ring seal is formed with multiple recesses arranged so as to be distributed over the circumference.

Here, according to a further aspect of the present disclosure, the flow cross sections of the recesses are, in sum total, configured such that, proceeding from a defined degree of wear of the slide ring seal in the region of the sealing side, proceeding from which the recesses open out in the region of the sealing side, an oil volume flow can be conducted through the recesses from the oil-conducting regions in the direction of the sealing side. Said oil volume flow is in turn greater than or equal to the predefined leakage oil volume flow.

According to a further aspect, the number and the cross section of the recesses are coordinated with one another such that the pressure drop on the high-pressure side of the slide ring seal is reliably detectable, and a component failure owing to an insufficient supply of oil does not occur.

As noted elsewhere herein, the present disclosure can relate to a gas turbine engine. Such a gas turbine engine can comprise an engine core which comprises a turbine, a combustion chamber, a compressor, and a core shaft that connects the turbine to the compressor. Such a gas turbine engine can comprise a fan (having fan blades) which is positioned upstream of the engine core.

Arrangements of the present disclosure can be particularly, although not exclusively, beneficial for fans that are driven via a gear box. Accordingly, the gas turbine engine can comprise a gear box that receives an input from the core shaft and outputs drive to the fan so as to drive the fan at a lower rotational speed than the core shaft. The input to the gear box can be performed directly from the core shaft or indirectly from the core shaft, for example via a spur shaft and/or a spur gear. The core shaft can be rigidly connected to the turbine and the compressor, such that the turbine and the compressor rotate at the same rotational speed (wherein the fan rotates at a lower rotational speed).

Additionally, the gas turbine engine comprises an above-described device. Here, one component of the device is coupled to a rotatable shaft of the gear box, preferably to a ring gear, a planet carrier or a sun gear, whereas the other component of the device is operatively connected rotationally fixedly to a housing of the gas turbine engine.

As an alternative to this, it is also possible for one component of the device to be operatively connected to a rotatable shaft of the gear box, which is preferably designed as a planetary gear box, and for the other component of the device to likewise be operatively connected to a rotatable shaft of the gear box.

The gas turbine engine as described and claimed herein can have any suitable general architecture. For example, the gas turbine engine can have any desired number of shafts, for example one, two or three shafts, that connect turbines and compressors. Purely by way of example, the turbine connected to the core shaft can be a first turbine, the compressor connected to the core shaft can be a first compressor, and the core shaft can be a first core shaft. The engine core can further comprise a second turbine, a second compressor, and a second core shaft which connects the second turbine to the second compressor. The second turbine, the second compressor, and the second core shaft can be arranged so as to rotate at a higher rotational speed than the first core shaft.

In such an arrangement, the second compressor can be positioned so as to be axially downstream of the first compressor. The second compressor can be arranged so as to receive (for example directly receive, for example via a generally annular duct) flow from the first compressor.

The gear box can be arranged so as to be driven by the core shaft (for example the first core shaft in the example above) that is configured to rotate (for example when in use) at the lowest rotational speed. For example, the gear box can be arranged so as to be driven only by the core shaft (for example only by the first core shaft and not by the second core shaft in the example above) that is configured to rotate (for example when in use) at the lowest rotational speed. Alternatively thereto, the gear box can be arranged so as to be driven by one or a plurality of shafts, for example the first and/or the second shaft in the example above.

In the case of a gas turbine engine which is described and claimed herein, a combustion chamber can be provided so as to be axially downstream of the fan and the compressor(s). For example, the combustion chamber can lie directly downstream of the second compressor (at the exit of the latter) when a second compressor is provided By way of further example, the flow at the exit of the compressor can be provided to the inlet of the second turbine, when a second turbine is provided. The combustion chamber can be provided so as to be upstream of the turbine(s).

The or each compressor (for example the first compressor and the second compressor as described above) can comprise any number of stages, for example multiple stages. Each stage can comprise a row of rotor blades and a row of stator vanes, the latter potentially being variable stator vanes (in that the angle of incidence of said stator vanes can be variable). The row of rotor blades and the row of stator blades can be axially offset from one another.

The or each turbine (for example the first turbine and the second turbine as described above) can comprise any number of stages, for example multiple stages. Each stage can comprise a row of rotor blades and a row of stator blades. The row of rotor blades and the row of stator blades can be axially offset from one another.

Each fan blade can be defined as having a radial span extending from a root (or a hub) at a radially inner location flowed over by gas, or at a 0% span width position, to a tip at a 100% span width position. The ratio of the radius of the fan blade at the hub to the radius of the fan blade at the tip can be less than (or of the order of): 0.4, 0.39, 0.38, 0.37, 0.36, 0.35, 0.34, 0.33, 0.32, 0.31, 0.3, 0.29, 0.28, 0.27, 0.26 or 0.25. The ratio of the radius of the fan blade at the hub to the radius of the fan blade at the tip can be in an inclusive range delimited by two of the values in the previous sentence (that is to say that the values can form upper or lower limits). These ratios can commonly be referred to as the hub-to-tip ratio. The radius at the hub and the radius at the tip can both be measured at the leading periphery (or the axially frontmost periphery) of the blade. The hub-to-tip ratio refers, of course, to that portion of the fan blade which is flowed over by gas, that is to say the portion that is situated radially outside any platform.

The radius of the fan can be measured between the engine centreline and the tip of the fan blade at the leading periphery of the latter. The diameter of the fan (which may simply be double the radius of the fan) can be larger than (or of the order of): 250 cm (approximately 100 inches), 260 cm, 270 cm (approximately 105 inches), 280 cm (approximately 110 inches), 290 cm (approximately 115 inches), 300 cm (approximately 120 inches), 310 cm, 320 cm (approximately 125 inches), 330 cm (approximately 130 inches), 340 cm (approximately 135 inches), 350 cm, 360 cm (approximately 140 inches), 370 cm (approximately 145 inches), 380 cm (approximately 150 inches), or 390 cm (approximately 155 inches). The fan diameter can be in an inclusive range delimited by two of the values in the previous sentence (that is to say that the values can form upper or lower limits).

The rotational speed of the fan can vary during use. Generally, the rotational speed is lower for fans with a comparatively large diameter. Purely by way of non-limiting example, the rotational speed of the fan at cruise conditions can be less than 2500 rpm, for example less than 2300 rpm. Purely by way of further non-limiting example, the rotational speed of the fan at cruise conditions for an engine having a fan diameter in the range from 250 cm to 300 cm (for example 250 cm to 280 cm) can also be in the range from 1700 rpm to 2500 rpm, for example in the range from 1800 rpm to 2300 rpm, for example in the range from 1900 rpm to 2100 rpm. Purely by way of further non-limiting example, the rotational speed of the fan at cruise conditions for an engine having a fan diameter in the range from 320 cm to 380 cm can be in the range from 1200 rpm to 2000 rpm, for example in the range from 1300 rpm to 1800 rpm, for example in the range from 1400 rpm to 1600 rpm.

During use of the gas turbine engine, the fan (with associated fan blades) rotates about an axis of rotation. This rotation results in the tip of the fan blade moving with a speed Uₜᵢₚ. The work done by the fan blades on the flow results in an enthalpy rise dH in the flow. A fan tip loading can be defined as dH/Uₜᵢₚ², where dH is the enthalpy rise (for example the 1-D average enthalpy rise) across the fan and Uₜᵢₚ is the (translational) velocity of the fan tip, for example at the leading periphery of the tip (which can be defined as the fan tip radius at the leading periphery multiplied by the angular speed). The fan tip loading at cruise conditions can be more than (or of the order of): 0.3, 0.31, 0.32, 0.33, 0.34, 0.35, 0.36, 0.37, 0.38, 0.39, or 0.4 (wherein all units in this passage are Jkg⁻¹K⁻¹/(ms⁻¹)²). The fan tip loading can be in an inclusive range delimited by two of the values in the previous sentence (that is to say that the values can form upper or lower limits).

Gas turbine engines in accordance with the present disclosure can have any desired bypass ratio, wherein the bypass ratio is defined as the ratio of the mass flow rate of the flow through the bypass duct to the mass flow rate of the flow through the core under cruise conditions. In the case of some arrangements, the bypass ratio can be more than (or of the order of): 10, 10.5, 11, 11.5, 12, 12.5, 13, 13.5, 14, 14.5, 15, 15.5, 16, 16.5, or 17. The bypass ratio can be in an inclusive range delimited by two of the values in the previous sentence (that is to say that the values can form upper or lower limits). The bypass duct can be substantially annular. The bypass duct can be situated radially outside the engine core. The radially outer surface of the bypass duct can be defined by an engine nacelle and/or a fan casing.

The overall pressure ratio of a gas turbine engine as described and claimed herein can be defined as the ratio of the stagnation pressure upstream of the fan to the stagnation pressure at the exit of the highest pressure compressor (before the entry to the combustion chamber). By way of non-limiting example, the overall pressure ratio of a gas turbine engine as described and claimed herein at cruise can be greater than (or of the order of): 35, 40, 45, 50, 55, 60, 65, 70, 75. The overall pressure ratio can be in an inclusive range delimited by two of the values in the previous sentence (that is to say that the values can form upper or lower limits).

The specific thrust of a gas turbine engine can be defined as the net thrust of the gas turbine engine divided by the total mass flow through the engine. The specific thrust of an engine as described and/or claimed herein at cruise conditions can be less than (or of the order of): 110 Nkg⁻¹s, 105 Nkg⁻¹s, 100 Nkg⁻¹s, 95 Nkg⁻¹s, 90 Nkg⁻¹s, 85 Nkg⁻¹s or 80 Nkg⁻¹s. The specific thrust can be in an inclusive range delimited by two of the values in the previous sentence (that is to say that the values can form upper or lower limits). Such gas turbine engines can be particularly efficient in comparison with conventional gas turbine engines.

A gas turbine engine as described and claimed herein can have any desired maximum thrust. Purely by way of a non-limiting example, a gas turbine as described and/or claimed herein can be capable of generating a maximum thrust of at least (or of the order of): 160 kN, 170 kN, 180 kN, 190 kN, 200 kN, 250 kN, 300 kN, 350 kN, 400 kN, 450 kN, 500 kN, or 550 kN. The maximum thrust can be in an inclusive range delimited by two of the values in the previous sentence (that is to say that the values can form upper or lower limits). The thrust referred to above can be the maximum net thrust at standard atmospheric conditions at sea level plus 15 degrees C. (ambient pressure 101.3 kPa, temperature 30 degrees C.) in the case of a static engine.

In use, the temperature of the flow at the entry to the high pressure turbine can be particularly high. This temperature, which can be referred to as TET, can be measured at the exit to the combustion chamber, for example directly upstream of the first turbine blade, which in turn can be referred to as a nozzle guide blade. At cruising speed, the TET can be at least (or of the order of): 1400K, 1450K, 1500K, 1550K, 1600K, or 1650K. The TET at cruising speed can be in an inclusive range delimited by two of the values in the previous sentence (that is to say that the values can form upper or lower limits). The maximum TET in the use of the engine can be at least (or of the order of), for example: 1700K, 1750K, 1800K, 1850K, 1900K, 1950K, or 2000K. The maximum TET can be in an inclusive range delimited by two of the values in the previous sentence (that is to say that the values can form upper or lower limits). The maximum TET can occur, for example, under a high thrust condition, for example under a maximum take-off thrust (MTO) condition.

A fan blade and/or an airfoil portion of a fan blade as described herein can be manufactured from any suitable material or a combination of materials. For example, at least a part of the fan blade and/or of the airfoil can be manufactured at least in part from a composite, for example a metal matrix composite and/or an organic matrix composite, such as carbon fibre. By way of a further example, at least a part of the fan blade and/or of the airfoil can be manufactured at least in part from a metal, such as a titanium-based metal or an aluminum-based material (such as an aluminum-lithium alloy) or a steel-based material. The fan blade can comprise at least two regions which are manufactured using different materials. For example, the fan blade can have a protective leading periphery, which is manufactured using a material that is better able to resist impact (for example of birds, ice, or other material) than the rest of the blade. Such a leading periphery can, for example, be manufactured using titanium or a titanium-based alloy. Thus, purely by way of example, the fan blade can have a carbon-fiber-based or aluminum-based body (such as an aluminum-lithium alloy) with a titanium leading periphery.

A fan as described herein can comprise a central portion from which the fan blades can extend, for example in a radial direction. The fan blades can be attached to the central portion in any desired manner. For example, each fan blade can comprise a fixing device which can engage with a corresponding slot in the hub (or disk). Purely by way of example, such a fixing device can be in the form of a dovetail that can be inserted into and/or engage with a corresponding slot in the hub/disk in order for the fan blade to be fixed to the hub/disk. By way of further example, the fan blades can be formed integrally with a central portion. Such an arrangement can be referred to as a blisk or a bling. Any suitable method can be used to manufacture such a blisk or such a bling. For example, at least a part of the fan blades can be machined from a block and/or at least a part of the fan blades can be attached to the hub/disk by welding, such as linear friction welding, for example.

The gas turbine engines as described and claimed herein may or may not be provided with a variable area nozzle (VAN). Such a variable area nozzle can allow the exit cross section of the bypass duct to be varied during use. The general principles of the present disclosure can apply to engines with or without a VAN.

The fan of a gas turbine engine as described and claimed herein can have any desired number of fan blades, for example 16, 18, 20, or 22 fan blades.

As used herein, cruise conditions can mean cruise conditions of an aircraft to which the gas turbine engine is attached. Such cruise conditions can be conventionally defined as the conditions at mid-cruise, for example the conditions experienced by the aircraft and/or the gas turbine engine between end of climb and start of descent (in terms of time and/or distance).

Purely by way of example, the forward speed at the cruise condition can be any point in the range of from Mach 0.7 to 0.9, for example 0.75 to 0.85, for example 0.76 to 0.84, for example 0.77 to 0.83, for example 0.78 to 0.82, for example 0.79 to 0.81, for example of the order of Mach 0.8, of the order of Mach 0.85 or in the range of from 0.8 to 0.85. Any arbitrary speed within these ranges can be the constant cruise condition. In the case of some aircraft, the constant cruise conditions may be outside these ranges, for example below Mach 0.7 or above Mach 0.9.

Purely by way of example, the cruise conditions can correspond to standard atmospheric conditions at an altitude that is in the range from 10,000 m to 15,000 m, for example in the range from 10,000 m to 12,000 m, for example in the range from 10,400 m to 11,600 m (around 38,000 ft), for example in the range from 10,500 m to 11,500 m, for example in the range from 10,600 m to 11,400 m, for example in the range from 10,700 m (around 35,000 ft) to 11,300 m, for example in the range from 10,800 m to 11,200 m, for example in the range from 10,900 m to 11,100 m, for example in the region of 11,000 m. The cruise conditions can correspond to standard atmospheric conditions at any given altitude in these ranges.

Purely by way of example, the cruise conditions can correspond to the following: a forward Mach number of 0.8; a pressure of 23,000 Pa; and a temperature of −55 degrees C.

As used anywhere herein, “cruising speed” or “cruise conditions” can mean the aerodynamic design point. Such an aerodynamic design point (or ADP) can correspond to the conditions (including, for example, the Mach number, environmental conditions, and thrust requirement) for which the fan operation is designed. This can mean, for example, the conditions at which the fan (or the gas turbine engine) has optimum efficiency in terms of construction.

When in use, a gas turbine engine as described and claimed herein can operate at the cruise conditions defined elsewhere herein. Such cruise conditions can be determined by the cruise conditions (for example the mid-cruise conditions) of an aircraft to which at least one (for example 2 or 4) gas turbine engine can be fastened in order to provide the thrust force.

A person skilled in the art will understand that a feature or parameter which is described in relation to one of the above aspects can be applied with any other aspect, unless they are mutually exclusive. Moreover, any feature or any parameter which is described here can be applied with any aspect and/or can be combined with any other feature or parameter described here, unless they are mutually exclusive.

Embodiments will now be described by way of example with reference to the figures.

In the figures:

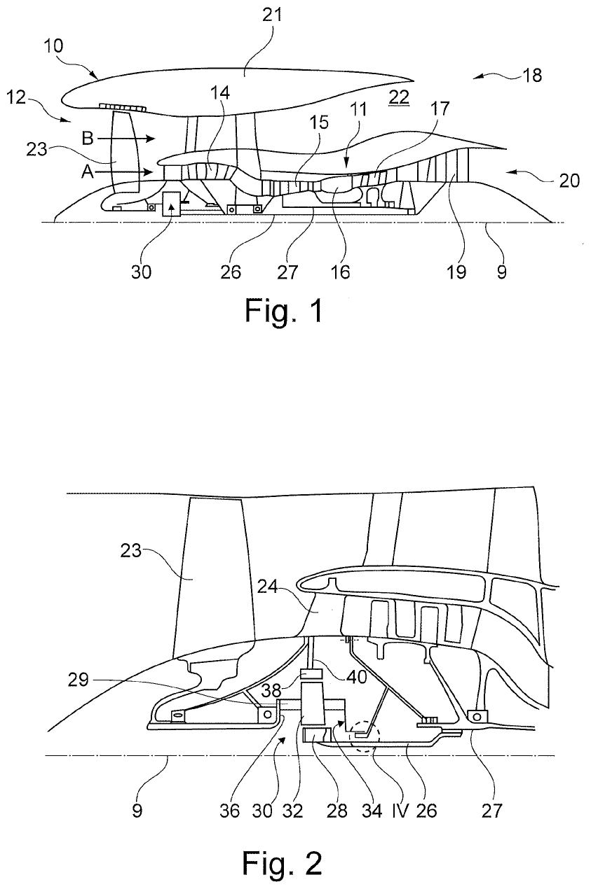

FIG. 1 shows a longitudinal section through a gas turbine engine;

FIG. 2 shows an enlarged partial longitudinal sectional view of an upstream portion of a gas turbine engine;

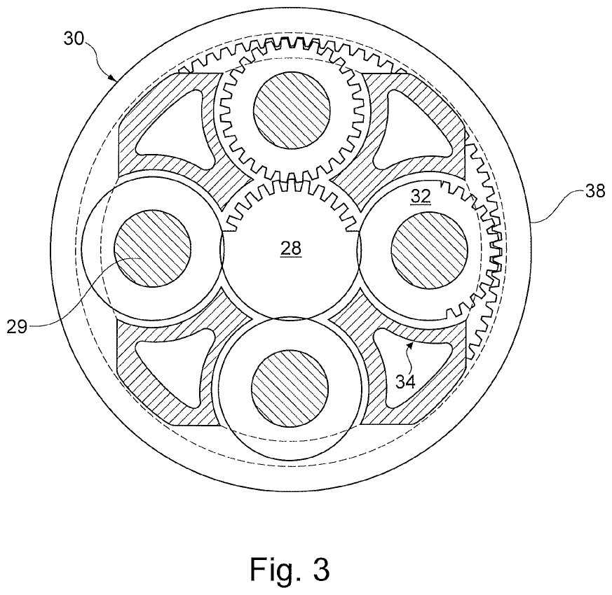

FIG. 3 shows an isolated illustration of a gear box for a gas turbine engine;

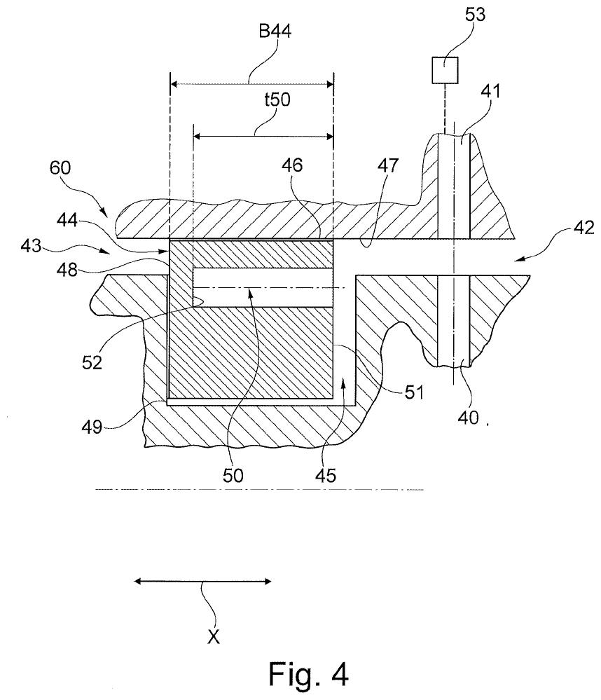

FIG. 4 shows a highly simplified detail sectional view of a region IV indicated in more detail in FIG. 2;

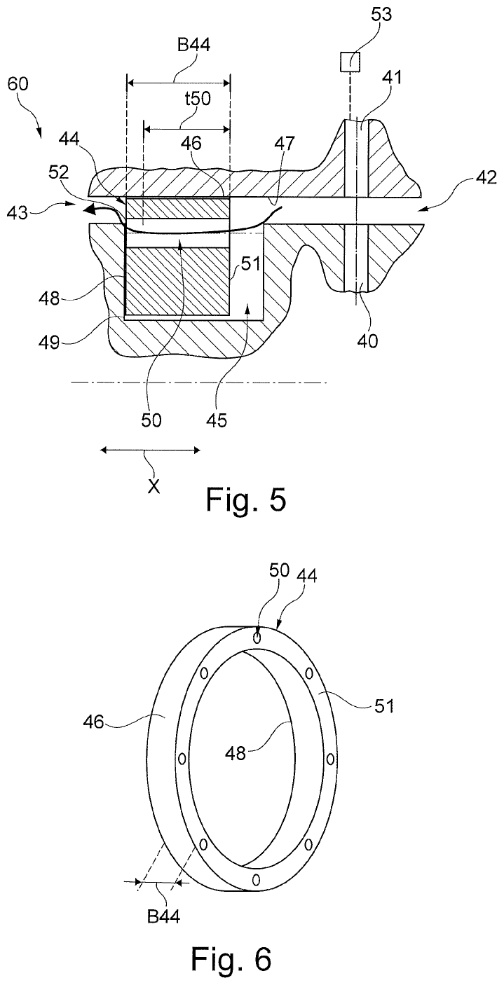

FIG. 5 shows an illustration corresponding to FIG. 4, wherein a slide ring seal shown in FIG. 5 exhibits a higher degree of wear in the region of a sealing surface than the state shown in FIG. 4; and

FIG. 6 shows a schematic three-dimensional illustration of the slide ring seal as per FIG. 4 and FIG. 5 on its own.

FIG. 1 illustrates a gas turbine engine 10 with a primary axis of rotation 9. The engine 10 comprises an air intake 12 and a thrust fan 23 that generates two air flows: a core air flow A and a bypass air flow B. The gas turbine engine 10 comprises a core 11 which receives the core air flow A. In the sequence of axial flow, the engine core 11 comprises a low-pressure compressor 14, a high-pressure compressor 15, a combustion device 16, a high-pressure turbine 17, a low-pressure turbine 19, and a core thrust nozzle 20. An engine nacelle 21 surrounds the gas turbine engine 10 and defines a bypass duct 22 and a bypass thrust nozzle 18. The bypass air flow B flows through the bypass duct 22. The fan 23 is attached to and driven by the low pressure turbine 19 by way of a shaft 26 and an epicyclic gear box 30. In this context, the shaft 26 is also referred to as a core shaft.

During use, the core air flow A is accelerated and compressed by the low-pressure compressor 14 and directed into the high-pressure compressor 15, where further compression takes place. The compressed air expelled from the high-pressure compressor 15 is directed into the combustion device 16, where it is mixed with fuel and the mixture is combusted. The resultant hot combustion products then expand through, and thereby drive, the high-pressure and low-pressure turbines 17, 19 before being expelled through the nozzle 20 to provide some propulsive thrust. The high-pressure turbine 17 drives the high-pressure compressor 15 by way of a suitable connecting shaft 27, which is also referred to as the core shaft. The fan 23 generally provides the majority of the propulsion force. The epicyclic gear box 30 is a reduction gear box.

An exemplary arrangement for a geared fan gas turbine engine 10 is shown in FIG. 2. The low-pressure turbine 19 (see FIG. 1) drives the shaft 26, which is coupled to a sun gear 28 of the epicyclic gear box assembly 30. A plurality of planet gears 32, which are coupled to one another by way of a planet carrier 34, are situated radially outside the sun gear 28 and mesh with the latter, and are in each case disposed so as to be rotatable on carrier elements 29 that are connected to the planet carrier 34 for conjoint rotation therewith. The planet carrier 34 limits the planet gears 32 to orbiting around the sun gear 28 in a synchronous manner while enabling each planet gear 32 to rotate about its own axis on the carrier elements 29. The planet carrier 34 is coupled by way of linkages 36 to the fan 23 so as to drive the rotation of the latter about the engine axis 9. Radially to the outside of the planet gears 32 and meshing therewith is an annulus or ring gear 38 that is coupled, via linkages 40, to a stationary supporting structure 24.

It is noted that the terms “low-pressure turbine” and “low-pressure compressor” as used herein can be taken to mean the lowest-pressure turbine stage and the lowest-pressure compressor stage (that is to say not including the fan 23) respectively and/or the turbine and compressor stages that are connected to one another by the connecting shaft 26 with the lowest rotational speed in the engine (that is to say not including the gear box output shaft that drives the fan 23). In some documents, the “low-pressure turbine” and the “low-pressure compressor” referred to herein can alternatively be known as the “intermediate-pressure turbine” and “intermediate-pressure compressor”. Where such alternative nomenclature is used, the fan 23 can be referred to as a first compression stage or lowest-pressure compression stage.

The epicyclic gear box 30 is shown in greater detail by way of example in FIG. 3. Each of the sun gear 28, the planet gears 32 and the ring gear 38 comprise teeth about their periphery to mesh with the other gears. However, for clarity, only exemplary portions of the teeth are illustrated in FIG. 3. Although four planet gears 32 are illustrated, it will be apparent to the person skilled in the art that more or fewer planet gears 32 can be provided within the scope of protection of the claimed invention. Practical applications of an epicyclic gear box 30 generally comprise at least three planet gears 32.

The epicyclic gear box 30 illustrated by way of example in FIGS. 2 and 3 is of the planetary type, in which the planet carrier 34 is coupled to an output shaft via linkages 36, wherein the ring gear 38 is fixed. However, any other suitable type of epicyclic gear box 30 can be used. By way of a further example, the epicyclic gear box 30 can be a star arrangement, in which the planet carrier 34 is held so as to be fixed, with the ring gear (or annulus) 38 allowed to rotate. In the case of such an arrangement, the fan 23 is driven by the ring gear 38. By way of a further alternative example, the gear box 30 can be a differential gear box in which the ring gear 38 and the planet carrier 34 are both allowed to rotate.

It will be appreciated that the arrangement shown in FIGS. 2 and 3 is only exemplary, and various alternatives are within the scope of protection of the present disclosure. Purely by way of example, any suitable arrangement can be used for positioning the gear box 30 in the engine 10 and/or for connecting the gear box 30 to the engine 10. By way of a further example, the connections (such as the linkages 36, 40 in the example of FIG. 2) between the gear box 30 and other parts of the engine 10 (such as the input shaft 26, the output shaft and the fixed structure 24) can have a certain degree of stiffness or flexibility. By way of a further example, any suitable arrangement of the bearings between rotating and stationary parts of the engine (for example between the input and output shafts of the gear box and the fixed structures, such as the gear box casing) can be used, and the disclosure is not limited to the exemplary arrangement of FIG. 2. For example, where the gear box 30 has a star arrangement (described above), the person skilled in the art would readily understand that the arrangement of output and support linkages and bearing positions would usually be different than that shown by way of example in FIG. 2.

Accordingly, the present disclosure extends to a gas turbine engine having an arbitrary arrangement of gear box types (for example star-shaped or planetary), support structures, input and output shaft arrangement, and bearing positions.

Optionally, the gear box may drive additional and/or alternative components (e.g. the intermediate-pressure compressor and/or a booster compressor).

Other gas turbine engines to which the present disclosure can be applied may have alternative configurations. For example, engines of this type may have an alternative number of compressors and/or turbines and/or an alternative number of connecting shafts. By way of further example, the gas turbine engine shown in FIG. 1 has a split flow nozzle 20, 22, meaning that the flow through the bypass duct 22 has a dedicated nozzle that is separate from and radially outside the engine core nozzle 20. However, this is not limiting, and any aspect of the present disclosure can also apply to engines in which the flow through the bypass duct 22 and the flow through the core 11 are mixed, or combined, before (or upstream of) a single nozzle, which can be referred to as a mixed-flow nozzle. One or both nozzles (whether mixed or split flow) can have a fixed or variable region. While the example described relates to a turbofan engine, the disclosure can be applied, for example, to any type of gas turbine engine, such as an open-rotor engine (in which the fan stage is not surrounded by an engine nacelle) or a turboprop engine.

The geometry of the gas turbine engine 10, and components thereof, is or are defined using a conventional axis system which comprise an axial direction (which is aligned with the axis of rotation 9), a radial direction (in the direction from bottom to top in FIG. 1), and a circumferential direction (perpendicular to the view in FIG. 1). The axial, radial and circumferential directions run so as to be mutually perpendicular.

FIG. 4 shows a highly schematic sectional view of a region IV, indicated in more detail in FIG. 2, of the gas turbine engine 10. Here, the illustration in FIG. 4 shows a device 60 having two components, wherein the first component corresponds in the present case to the planet carrier 34 and the second component corresponds to the support structure 24. The first component 34 is thus designed to be rotatable, whereas the second component 24 is fixed to a housing and is thus formed so as not to be rotatable. Components 24 and 34 each comprise oil-conducting regions 40, 41.

For the purposes of transferring oil, the oil-conducting regions 40 and 41 are operatively connected to one another via an overlap region 42 between the components 24 and 34. In the present case, the overlap region 42 is delimited by means of a sealing unit 43 which comprises two slide ring seals 44, wherein only one of the two slide ring seals 44 is shown in FIG. 4.

The second slide ring seal of the sealing unit 43 is arranged on the opposite side, in the axial direction x, of the two oil-conducting regions 40 and 41. The two slide ring seals 44 of the sealing unit 43 are each arranged in a radial groove 45 of the component 24, wherein, again, only one of the two radial grooves 45 is illustrated in FIG. 4. The rotatable component 34 surrounds the static component 24 in a radial direction. For the sealing of the oil-conducting regions 40 and 41, the slide ring seal 44 bears with its radial outer side 46 sealingly against an inner side 47 of the rotatable component 34. Additionally, the slide ring seal 44 bears with an axial sealing surface 48 sealingly against a side wall 49 of the radial groove 45.

During the operation of the gas turbine engine 10, the planet carrier 34 rotates at a high rotational speed, whereas the support structure 24 is static. Additionally, the slide ring seal 44 rotates together with the planet carrier 34, whereby a large rotational speed difference prevails in the region between the sealing surface 48 and the side wall 49 of the radial groove 45. This rotational speed difference, together with the radial offset movements between the components 24 and 34 and in a manner dependent on a friction coefficient between the sealing surface 48 and the side wall 49, gives rise to increasing wear over the course of the operating duration. In the long term, this wear leads to a reduction in the sealing performance of the sealing unit 43, as a result of which the sealing unit 43, or the slide ring seals 44 thereof, must be replaced with new slide ring seals after predefined maintenance intervals have elapsed.

Here, these maintenance intervals are configured such that the slide ring seals 44 are exchanged before the loss of sealing performance of the sealing unit 43. Since unfavorable operating state profiles of the gas turbine engine 10 can cause undesirably high levels of wear in the region of the slide ring seals 44, it is possible that the sealing performance of the sealing unit 43 decreases already before such a maintenance interval has elapsed. A supply of oil to the gear box 30 from the support structure 24 and via the planet carrier 34 is then no longer ensured to the required degree.

For this reason, the slide ring seals 44 are formed with multiple recesses 50, to the extent illustrated in more detail in FIG. 4 to FIG. 6. The recesses 50 are arranged so as to be distributed over the circumference of the slide ring seal 44 and are formed as blind bores. Furthermore, the recesses 50 extend from a sealing side 51 of the slide ring seal 44 in an axial direction x in the direction of the opposite axial sealing surface or of the sealing side 48. Here, an axial depth t50 of the recesses 50 is in each case smaller than an axial width B44 of the slide ring seal 44. The difference between the axial width B44 and the axial depth t50 corresponds to a spacing between the axial sealing side 48 and an end 52 of the recesses 50.

The spacing between the end 52 of the recesses 50 and the axial sealing side 48 is configured such that an expected degree of operational wear of the slide ring seal 44 in the region of the sealing surface 48 over a defined operating duration, which is associated with a defined abrasive removal of material in the region of the sealing surface 48, is smaller than the wall thickness, corresponding to the spacing, of the slide ring seal between the sealing surface 48 and the end 52 of the recesses 50.

In the event that the degree of wear in the region of the sealing surface 48 over the course of the operating duration is greater than the spacing between the sealing surface 48 and the end 52 of the recesses 50, the recesses 50 open out in the region of the sealing surface 48. In such a state of the slide ring seal 44, the oil-conducting regions 40 and 41 are connected via the recesses 50 to the region, facing toward the sealing surface 48, between the components 24 and 34. Thus, oil can be conducted through the recesses 50 from the oil-conducting regions 40 and 41 through the sealing unit 43. Here, the oil volume flow that can be conducted out of the oil-conducting regions 40 and 41 via the recesses 50 is so small that a supply of oil to the gear box 30 via the oil-conducting regions 40 and 41 is not impaired.

This outflowing leakage oil volume flow has the effect that the pressure in the region of the oil-conducting regions 40 and 41 decreases abruptly. This pressure drop is detected by measurement in the region of a pressure sensor 53, and is fed as a sensor signal or input signal to a control unit of the gas turbine engine 10. In the presence of such a sensor signal, the control unit outputs a corresponding warning signal to the effect that, in the region of the sealing unit 43, a defined degree of wear is present which necessitates an exchange of the slide ring seals 44.

### LIST OF REFERENCE SIGNS

9 Primary axis of rotation
10 Gas turbine engine
11 Core
12 Air intake
14 Low-pressure compressor
15 High-pressure compressor
16 Combustion installation
17 High-pressure turbine
18 Bypass thrust nozzle
19 Low-pressure turbine
20 Core thrust nozzle
21 Engine nacelle
22 Bypass duct
23 Thrust fan
24 Support structure
26 Shaft, connecting shaft
27 Connecting shaft
28 Sun gear
30 Gear box, planetary gear box
32 Planet gear
34 Planet carrier
36 Linkage
38 Ring gear
40, 41 Oil-conducting region
42 Overlap region
43 Sealing unit
44 Slide ring seal
45 Radial groove
46 Radial outer side of the slide ring seal
47 Inner side of the planet carrier 34
48 Axial sealing surface of the slide ring seal
49 Side wall
50 Recess
51 Sealing side
52 End of the recess
53 Pressure sensor
60 Device
A Core air flow
B Bypass air flow
B44 Axial width of the slide ring seal
t50 Axial depth of the recess
x Axial direction of the sealing unit

1. A device having two components, wherein
at least one of the components is designed to be rotatable relative to the other component, and
the components each have oil-conducting regions,
which, for the purposes of transferring oil, are operatively connected to one another via an overlap region between the components
wherein the overlap region between the components is delimited by means of a sealing unit which has at least one slide ring seal,
wherein
the slide ring seal is designed with at least one recess
which is connected to the oil-conducting regions and which is formed so as to run in the direction of a sealing side, averted from the oil-conducting regions, of the slide ring seal,
by means of which sealing side the slide ring seal bears sealingly against at least one of the components,
wherein an end, which faces toward the sealing side, of the recess is spaced apart from the sealing side in an axial direction of the slide ring seal.

2. The device according to claim 1, wherein, proceeding from a defined degree of wear of the slide ring seal in the region of the sealing side, proceeding from which the recess opens out in the region of the sealing side, an oil volume flow can be conducted through the recess from the oil-conducting regions in the direction of the sealing side.

3. The device according to claim 2, wherein the oil volume flow that can be conducted through the recess is greater than or equal to a predefined leakage oil volume flow.

4. The device according to claim 3, wherein the predefined leakage oil volume flow is smaller than a degree of leakage proceeding from which an oil volume flow conducted from the component into the rotatable component is smaller than a threshold value.

5. The device according to claim 1, wherein the recess is designed as a blind bore running in an axial direction in the slide ring seal.

6. The device according to claim 1, wherein the recess is formed as an axial groove which is arranged in an outer side of the slide ring seal.

7. The device according to claim 1, wherein the spacing between the end of the recess and the sealing side is configured such that an expected degree of operational wear of the slide ring seal in the region of the sealing surface over a defined operating duration, which is associated with a defined abrasive removal of material, is smaller than the wall thickness, corresponding to the spacing, of the slide ring seal between the sealing surface and the end of the recess.

8. The device according to claim 1, wherein the rotatable component radially surrounds the other component, and the slide ring seal is arranged in a radial groove of the other component, wherein the slide ring seal bears sealingly with its radial outer side against an inner side of the rotating component and bears sealingly with the axial sealing side against a wall of the radial groove.

9. The device according to claim 1, wherein the recess is connected, in the region of a sealing side situated opposite the sealing side, to the oil-conducting regions.

10. The device according to claim 1, wherein the slide ring seal is formed with multiple recesses arranged so as to be distributed over the circumference, the flow cross sections of which recesses are, in sum total, configured such that, proceeding from a defined degree of wear of the slide ring seal in the region of the sealing side, proceeding from which the recesses open out in the region of the sealing side, an oil volume flow greater than or equal to the predefined leakage oil volume flow can be conducted through the recesses from the oil-conducting regions in the direction of the sealing side.

11. A gas turbine engine for an aircraft, comprising the following:
an engine core, which comprises a turbine, a compressor, and a core shaft, which connects the turbine to the compressor;
a fan, which is positioned upstream of the engine core, wherein the fan comprises a plurality of fan blades;
a gear box, which receives an input from the core shaft and outputs drive for the fan in order to drive the fan at a lower speed than the core shaft; and
a device according to claim 1, wherein one component of the device is coupled to a rotatable shaft of the gear box and the other component of the device is operatively connected rotationally conjointly to a housing of the gas turbine engine.

12. The gas turbine engine according to claim 11, wherein the turbine is a first turbine, the compressor is a first compressor, and the core shaft is a first core shaft;
the engine core further comprises a second turbine, a second compressor, and a second core shaft, which connects the second turbine to the second compressor; and
the second turbine, the second compressor and the second core shaft are arranged so as to rotate at a higher speed than the first core shaft.
